(19) United States
(12) Patent Application Publication
(10) Pub. No.: US 2014/0046844 A1
(43) Pub. Date: Feb. 13, 2014

(54) Transaction Security Using Location Authentication

(71) Applicant: David M. Grigg, Rock Hill, SC (US)

(72) Inventor: David M. Grigg, Rock Hill, SC (US)

(73) Assignee: Bank of America Corporation, Charlotte, NC (US)

(21) Appl. No.: 13/568,592

(22) Filed: Aug. 7, 2012

(51) Int. Cl. G06Q 20/40

(52) U.S. Cl. 705/44

(57) ABSTRACT

In certain embodiments, an method includes receiving an authorization request for a proposed transaction between a consumer and a retailer, the authorization request including transaction information associated with the proposed transaction. The method further includes accessing authentication information for the consumer and determining, based on the transaction information and the accessed authentication information, a risk score for the proposed transaction. The method further includes determining whether to grant the authorization request based on the determined risk score.

### TECHNICAL FIELD OF THE INVENTION

This disclosure relates generally to financial transactions and more particularly to transaction security using location authentication.

### BACKGROUND OF THE INVENTION

In order to purchase goods from a retailer, consumers often rely on the use of bank cards in lieu of a cash payment. Bank cards may be issued to the consumer by a card issuer (e.g., a bank) and may include either credit cards (cards that draw on a line of credit extended to the consumer by the card issuer) or debit cards (cards that draw from the consumer's bank account with the card issuer). Thus, the use of bank cards necessarily introduces a third party into the retailer-consumer transaction—the card issuer. In order to prevent unauthorized access to a line or credit or bank account associated with a bank card, the card issuer may require that the retailer get authorization from the card issuer prior to allowing the consumer to purchase goods using the bank card. If the card issuer determines that the requested transaction has a high likelihood of being fraudulent, the card issuer may choose not to authorize the requested transaction.

### SUMMARY OF THE INVENTION

According to embodiments of the present disclosure, disadvantages and problems associated with previous systems for transaction security may be reduced or eliminated.

In certain embodiments, a method includes receiving an authorization request for a proposed transaction between a consumer and a retailer, the authorization request including transaction information associated with the proposed transaction. The method further includes accessing authentication information for the consumer and determining, based on the transaction information and the accessed authentication information, a risk score for the proposed transaction. The method further includes determining whether to grant the authorization request based on the determined risk score.

Particular embodiments of the present disclosure may provide one or more technical advantages. For example, in certain embodiments of the present discourse, a decision regarding whether to grant an authorization request for a proposed transaction may be based on a risk score that takes into account both (1) transaction information received from the retailer (e.g., the name of the retailer and the location of the retailer, information obtained from the bank card by a card reader) and (2) authentication information specific to the consumer (e.g., a location of the consumer, which may be provided by the user or determined based on position information from the consumer's mobile device). Because the risk score takes into account both the transaction information and the consumer-specific authentication information, the risk score may account for any disparity between the two sets of information. In other words, if the bank card 106 is being used at a retailer location (as specified in the transaction information) that is different from the location of the consumer to which the bank card 106 is issued (as specified in the authentication information), a high risk score may be determined and the proposed transaction proposed transaction may be declined (as the disparity in location may indicate that a consumer other than the consumer to which the bank card 106 is issued is attempting to use the bank card 106). Accordingly, increased transaction security may be provided for the consumer to which the bank card is issued.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 illustrates an example system for providing transaction security using location authentication, according to certain embodiments of the present disclosure; and

FIG. 2 illustrates an example method for providing transaction security using location authentication, according to certain embodiments of the present disclosure.

### DETAILED DESCRIPTION OF THE INVENTION

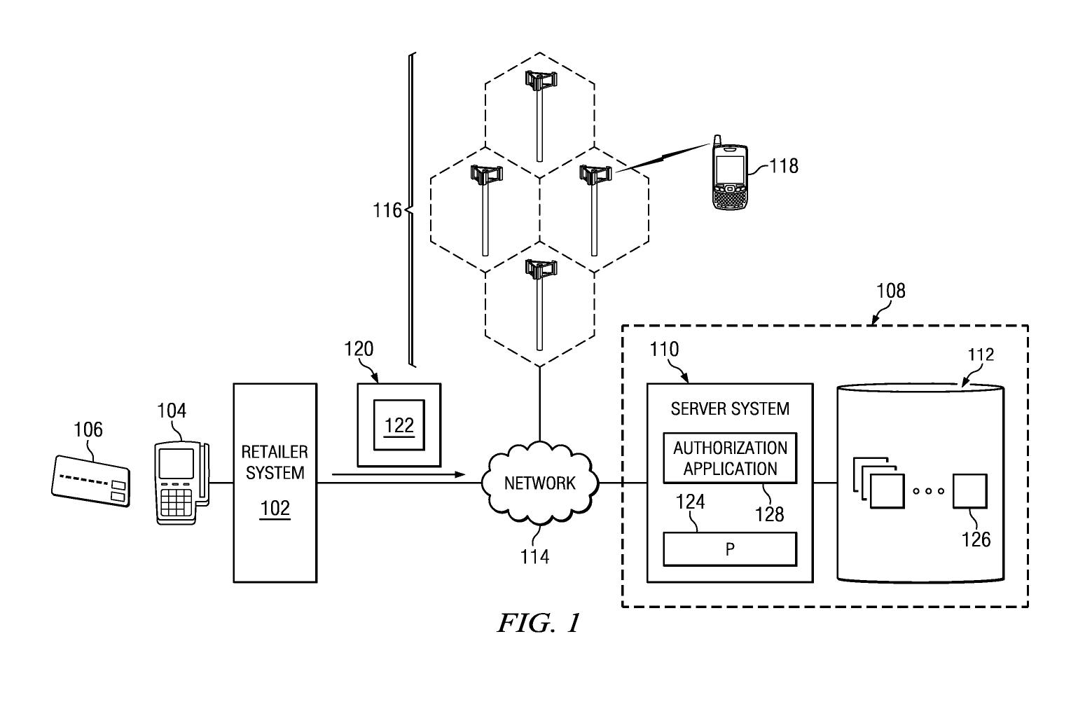

FIG. 1 illustrates an example system 100 for providing transaction security using location authentication, according to certain embodiments of the present disclosure. System 100 may include a retailer system 102 having a card reader 104 operable to read information from a bank card 106 of a consumer (e.g., a debit card, a credit card, or any other suitable card that may be used by a consumer to purchase goods from a retailer). Retailer system 102 may be configured to communicate with an authentication system 108 comprising a server system 110 and database 112 (e.g., via a network 114). In addition, one or more cellular networks 116 may be configured to communicate with authentication system 108 (e.g., via network 114) such that consumers may access authentication system 108 via mobile devices 118. Although this particular implementation of system 100 is illustrated and primarily described, the present invention contemplates any suitable implementation of system 100 according to particular needs.

In general, system 100 is operable to provide transaction security for consumers purchasing goods from retailers using bank cards 106. For example, when a consumer attempts to purchase goods from a retailer using a bank card 106, the retailer may seek authorization for the proposed transaction from the card issuer by sending an authorization request to an authorization system 108 of the card issuer. The authorization system 108 may base the authorization decision on a risk score determined based on both (1) transaction information received from the retailer system 102 (e.g., the name of the retailer, the location of the retailer, information obtained from the bank card 106 by a card reader 104, etc.), and (2) authentication information specific to the consumer (e.g., a location of the consumer, which may be provided by the user, determined based on position information from the consumer's mobile device 118, or obtained in any other suitable manner). Because the risk score takes into account both the transaction information received from the retailer and the consumer-specific authentication information, authentication system 108 may account for any disparity between the two sets of information when determining the risk score. As one particular example, if the bank card 106 is being used at a retailer location (as specified in the transaction information) that is different from the location of the consumer to which the bank card 106 is issued (as specified in the authentication information), authentication system 108 may determine a high risk score and decline the proposed transaction (as the disparity in location may indicate that a consumer other than the consumer to which the bank card 106 is issued is attempting to use the bank card 106). Accordingly, increased transaction security may be provided for the consumer to which the bank card 106 is issued.

Retailer system 102 may be located at a retailer location and may include any system or device used by the retailer (i.e., a seller of goods) to process proposed transactions with consumers. Retailer system 102 may include one or more computer systems at one or more locations, and each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of retailer system 102. Each computer system may include a personal computer, workstation, network computer, kiosk, wireless data port, personal data assistant (PDA), one or more processors within these or other devices, or any other suitable processing device.

Retailer system 102 may be communicatively coupled (e.g., via wireless or wireline communication) to a card reader 104, which may include any suitable device operable to read information from a bank card 106 of a consumer. For example, card reader 106 may comprise a magnetic stripe card reader operable to read information contained on a magnetic stripe of a bank card 106. Information contained on the magnetic stripe of a bank card 106 may include the name of the consumer to which the bank card 106 is issued, an account number for the consumer to which the card is issued, and/or any other suitable information relevant to proposed transactions using the bank card 106. Although a single retailer system 102 and card reader 104 are depicted and described, the present disclosure contemplates any suitable number of retailer systems 102 and card readers 104, according to particular needs.

Retailer system 102 may be communicatively coupled to authorization system 108 via network 114. Network 114 may facilitate wireless or wireline communication and may communicate, for example, IP packets, Frame Relay frames, Asynchronous Transfer Mode (ATM) cells, voice, video, data, and other suitable information between network addresses. Network 114 may include one or more local area networks (LANs), radio access networks (RANs), metropolitan area networks (MANs), wide area networks (WANs), all or a portion of the global computer network known as the Internet, and/or any other communication system or systems at one or more locations.

In certain embodiments, retailer system 102, in response to a proposed transaction involving a bank card 106, may communicate an authorization request 120 to authorization system 108 (which may be associated with the issuer of the bank card 106) via network 114. The authorization request 120 may include transaction information 122 for the proposed transaction. For example, the transaction information 122 may include information obtained by the card reader 104 from the bank card 106 (e.g., account information associated with the bank card 106 and the name of the account holder), information identifying the retailer (e.g., the name of the retailer and the location of the retailer), and any other suitable information related to the proposed transaction. Based on the transaction information 122 (as well as consumer-specific authorization information 126, discussed below), authorization system 108 may determine a risk score for the proposed transaction. If the risk score exceeds a predetermined value, authorization system 108 may decline the proposed transaction.

Authorization system 108 may include any suitable system operable to process authorization requests 120 received from retailer systems 102. In certain embodiments, authorization system 108 may include a server system 110 and a database 112. Server system 110 may include one or more electronic computing devices operable to receive, transmit, process, and store data associated with system 100. For example, server system 110 may include one or more general-purpose PCs, Macintoshes, workstations, Unix-based computers, server computers, one or more server pools, or any other suitable devices. In short, server system 110 may include any suitable combination of software, firmware, and hardware. Although a single server system 110 is illustrated, the present disclosure contemplates system 100 including any suitable number of server systems 110. Moreover, although referred to as a “server system,” the present disclosure contemplates server system 110 comprising any suitable type of processing device or devices.

Server system 110 may include one or more processing module 124, each of which may include one or more microprocessors, controllers, or any other suitable computing devices or resources. Processing modules 124 may work, either alone or with other components of system 100, to provide a portion or all of the functionality of system 100 described herein. Server system 110 may additionally include (or be communicatively coupled to) a database 112. Database 112 may comprise any suitable memory module and may take the form of volatile or non-volatile memory, including, without limitation, magnetic media, optical media, random access memory (RAM), read-only memory (ROM), removable media, or any other suitable local or remote memory component.

Database 112 may store authorization information 126 for consumers having bank cards 106 issued by the card issuer with which the authorization system 108 is associated. Authorization information 126 may include any suitable information associated with a particular consumer that may be used in determining a risk score for a proposed transaction in response to an authorization request 120.

In certain embodiments, authorization information 126 for a particular consumer may include anticipated travel plans (e.g., travel destination and the dates associated with those destinations). For example, a consumer may communicate anticipated travel plans to authentication system 108 via a mobile application on the mobile device 118 of the consumer, an Internet website, or in any other suitable manner. Accordingly, authentication system 108, in determining a risk score for a proposed transaction, may compare the anticipated travel destination received from the consumer (from the authentication information 126) with the location of the retailer of a proposed transaction (from the transaction information 122), as discussed in further detail below.

In certain other embodiments, authorization information 126 for a particular consumer may include a real-time location of the particular consumer. For example, a user desiring increased transaction security may grant permit authorization system 108 to access location information from the mobile device 118 of the consumer (e.g., a GPS location generated by the mobile device 118). The consumer may grant permission to authorization system 108 to access location information from the consumer's mobile device 118 via a mobile application on the consumer's mobile device 118, an Internet website, or in any other suitable manner. Information indicating that the consumer has granted permission to authorization system 108 may be stored as part of the authorization information 126 associated with the consumer. In certain embodiments, the granted permission may further indicate a prerequisite minimum dollar for accessing location information from the mobile device 118 of the consumer. In other words, the consumer may desire that authorization system 108 only access location information from the mobile device 118 of the consumer if a proposed transaction involving the bank card 106 of the consumer exceeds a minimum dollar amount. Accordingly, the user may achieve increased security only for those transaction perceived by the consumer to be high value.

In certain embodiments, server system 110 may include an authorization application 128, which may include any suitable combination of hardware, firmware, and software. In certain embodiments, authorization application 128 is operable to process authorization requests 120 received from retailer systems 102 in order to determine whether to grant those authorization requests.

Authorization application 120 may be operable to receive an authorization request 120 from a retailer system 102, the authorization request having been generated by the retailer system 102 in response to a proposed transaction involving a bank card 106. As discussed above, the authorization request 120 may include transaction information 122 generated by the retailer system 102 (e.g., consumer name and/or account information obtained from the bank card by a card reader 104, the retailer name, retailer location, etc.).

Authorization application 128 may be further operable to access authorization information 126 (e.g., stored in database 112) corresponding to the transaction information 122 of the authorization request 120. For example, authorization application 120 may search authorization information 126 to locate the particular authorization information 126 for the consumer and/or account specified in the received transaction information 122. As discussed above, the accessed authorization information 126 may include location information provided by the consumer (e.g., a travel itinerary). Additionally or alternatively, the authorization information 126 may include an indication from the consumer that authorization application 128 should access real-time location information for the consumer (e.g., a GPS location generated by the mobile device 118 of the consumer). In embodiments in which the authorization information 126 includes an indication from the consumer that authorization application 128 should access real-time location information for the consumer, authorization application 128 may communicate a request to the mobile device 118 of the consumer (e.g., via network 114 and/or cellular network 116) requesting the real-time location (e.g., GPS location) of the mobile device 118. The received real-time location may be stored as part of the consumer's authorization information 126 and used to determine a risk score for the proposed transaction for which the received authorization request 120 was generated, as discussed below.

Authorization application 128 may be further operable to generate risk score for the proposed transaction for which the received authorization request 120 was generated. In certain embodiments, authorization application 128 may determine the risk score based on both (1) the transaction information 122 included with the authorization request 120, and (2) the accessed authorization information 126 for the consumer/account specified in the transaction information 122 (i.e., the consumer to which the bank card 106 used in the proposed transaction is issued). The present disclosure contemplates any suitable combination of transaction information 122 and authorization information 126 as being used to determine a risk score for a proposed transaction.

In certain embodiments, authorization application 128 may determine the risk score based at least in part on the retailer location (as specified in the transaction information 122) and the location of the consumer (pre-specified or real-time, as discussed above) to which bank card 106 is issued (as specified in the accessed authorization information 126). If the location of the consumer matches or is near the location of the retailer, a relatively low risk score may be determined. Alternatively, if the location of the consumer does not match or is not near the location of the retailer, a relatively high risk score may be determined (as such an inconsistency may indicate that someone other than the consumer to which the bank card 106 is issued is attempting to use the bank card 106). In certain embodiments, other factors may also affect the determined risk score, such as the amount of the proposed transaction (e.g., higher value transaction may result in a higher risk score) and the distance between the retailer location and the home address of the consumer to which the bank card 106 is issued (as transactions made closer to home may result in lower risk scores).

Authorization application 128 may be further operable to compare the determined risk score with a pre-defined maximum risk score in order to determine whether to grant the received authorization request 120. If the determined risk score exceeds the predefined maximum risk score, authorization application 128 may communicate a denial to retailer system 102 in response to the received the authorization request 120 and the consumer may not be allowed to complete the proposed transaction. Otherwise, authorization application 128 may communicate a allowance to retailer system 102 in response to the received the authorization request 120 and the consumer may be allowed to complete the proposed transaction.

In certain embodiments, authorization application 128 may be further operable to take an intermediate action (i.e., neither confirm nor deny the received the authorization request 120) in response to the determination of a risk score in an intermediate range. For example, in response to a determined risk score in an intermediate range, authorization application 128 may send a notification to the consumer to which the bank card 106 is issued (e.g., via a mobile device 118 of the consumer) to request confirmation regarding the proposed transaction.

Although a particular implementation of system 100 is illustrated and primarily described, the present disclosure contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

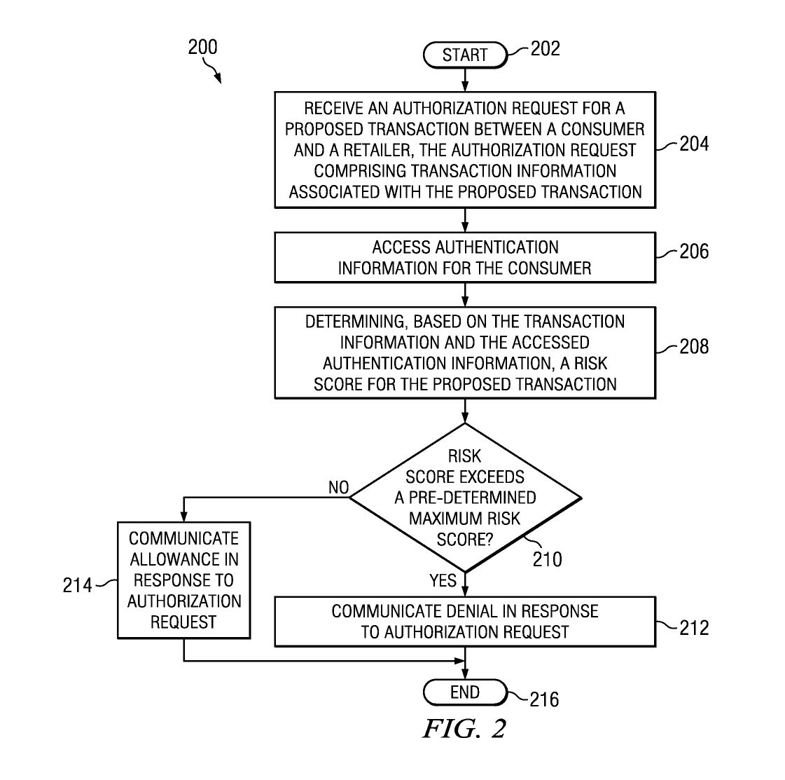

FIG. 2 illustrates an example method 200 for providing transaction security using location authentication, according to certain embodiments of the present disclosure. The method begins at step 202. At step 204, authorization system 108 receives an authorization request 120 from a retailer system 102. As discussed above, the authorization request 120 may have been generated by retailer system 102 in response to a proposed transaction involving a bank card 106. Additionally, the authorization request may include transaction information 122 associated with the proposed transaction (e.g., information obtained from the bank card 106 by a card reader 104 associated with the retailer system 102, a name of the retailer, and a location of the retailer).

At step 206, authorization system 108 accesses authentication information 126 for the consumer to which the bank card 106 involved in the proposed transaction was issued. For example, authorization system 108 may access authorization information 126 based on the name and/or account number of the consumer. As discussed above, the accessed authorization information 126 may include location information (pre-specified location or accessed real-time location, as discussed above) for the consumer to which the bank card 106 was issued.

At step 208, authorization system 108 determines, based on both the transaction information 122 and the accessed authentication information 126, a risk score for the proposed transaction. As discussed above, the risk score may be determined based at least in part on the retailer location (as specified in the transaction information 122) and the location of the consumer to which bank card 106 is issued (as specified in the accessed authorization information 126). As a result, any inconsistency between the location of the retailer and the location of the consumer (which may indicate that someone other than the consumer to which the bank card 106 is issued is attempting to use the bank card 106) may lead to a higher risk score.

At step 210, authorization system 108 determined whether the determined risk score exceeds a pre-determined maximum risk score. If so, the method proceeds to step 212 and authorization system 108 communicates a denial to the retailer system 102 in response to the received authorization request (i.e., the proposed transaction is denied). Alternatively, the method proceeds to step 214 and authorization system 108 communicates an allowance to the retailer system 102 in response to the received authorization request 120 (i.e., the proposed transaction is allowed). The method ends at step 216.

Although the steps of method 200 have been described as being performed in a particular order, the present disclosure contemplates that the steps of method 200 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

1. A method, comprising:
receiving, by at least one computer, an authorization request from a retailer for a proposed transaction between a consumer and the retailer, the authorization request comprising transaction information associated with the proposed transaction, the transaction information comprising the location of the retailer requesting the proposed transaction;
accessing, by the at least one computer, authentication information for the consumer, wherein the authorization information comprises a real-time GPS location of the consumer associated with the proposed transaction, the real-time GPS location generated by a mobile device of the consumer associated with the proposed transaction;
comparing the real-time GPS location of the consumer with the location of the retailer identified in the authorization request for the proposed transaction;
determining, based on the comparison of the transaction information comprising the location of the retailer requesting the proposed transaction and the accessed authentication information comprising the real-time GPS location of the consumer associated with the proposed transaction, a risk score for the proposed transaction; and
determining, by the at least one computer, whether to grant the authorization request based on the determined risk score.

2. The method of claim 1, wherein the transaction information comprises one or more of:
a name of the consumer;
a name of the retailer;
a location of the retailer; and
a dollar amount for the proposed transaction.

3. The method of claim 1, wherein:
the authorization request is generated by the retailer in response to the consumer requesting the proposed transaction; and
at least a portion of the transaction information is obtained by the retailer based on a bank card provided by the consumer.

4. (canceled)

5. (canceled)

6. The method of claim 5, wherein the determined risk score is increased if the real-time GPS location of the consumer does not match the location of the retailer.

7. (canceled)

8. (canceled)

9. The method of claim 1, wherein the transaction information comprises a dollar amount for the proposed transaction, the method further comprising:
comparing the dollar amount for the proposed transaction with a minimum transaction amount specified by the consumer; and
accessing the authentication information for the consumer in response to determining that the dollar amount for the proposed transaction exceeds the minimum transaction amount specified by the consumer.

10. A system, comprising:
one or more memory modules storing authentication information for a consumer; and
one or more processing modules operable to:
receive, from a retailer, an authorization request for a proposed transaction between the consumer and the retailer, the authorization request comprising transaction information associated with the proposed transaction, the transaction information comprising the location of the retailer requesting the proposed transaction;
access authentication information for the consumer, wherein the authorization information comprises a real-time GPS location of the consumer associated with the proposed transaction, the real-time GPS location generated by a mobile device of the consumer associated with the proposed transaction;
compare the real-time GPS location of the consumer with the location of the retailer identified in the authorization request for the proposed transaction;
determine, based on the comparison of the transaction information comprising the location of the retailer requesting the proposed transaction and the accessed authentication information comprising the real-time GPS location of the consumer associated with the proposed transaction, a risk score for the proposed transaction; and
determine whether to grant the authorization request based on the determined risk score.

11. The system of claim 10, wherein the transaction information comprises one or more of:
a name of the consumer;
a name of the retailer;
a location of the retailer; and
a dollar amount for the proposed transaction.

12. The system of claim 10, wherein:
the authorization request is generated by the retailer in response to the consumer requesting the proposed transaction; and
at least a portion of the transaction information is obtained by the retailer based on a bank card provided by the consumer.

13. (canceled)

14. (canceled)

15. The system of claim 14, wherein the determined risk score is increased if the real-time GPS location of the consumer does not match the location of the retailer.

16. (canceled)

17. (canceled)

18. The system of claim 10, wherein:
the transaction information comprises a dollar amount for the proposed transaction; and
the one or more processing modules are further operable to:
compare the dollar amount for the proposed transaction with a minimum transaction amount specified by the consumer; and
access the authentication information for the consumer in response to determining that the dollar amount for the proposed transaction exceeds the minimum transaction amount specified by the consumer.

19. A non-transitory computer-readable medium encoded with logic, the logic operable when executed to:
receive, from a retailer, of an authorization request for a proposed transaction between a consumer and the retailer, the authorization request comprising transaction information associated with the proposed transaction, the transaction information comprising the location of the retailer requesting the proposed transaction;
access authentication information for the consumer, wherein the authorization information comprises a real-time GPS location of the consumer associated with the proposed transaction, the real-time GPS location generated by a mobile device of the consumer associated with the proposed transaction;
compare the real-time GPS location of the consumer with the location of the retailer identified in the authorization request for the proposed transaction;
determine, based on the comparison of the transaction information comprising the location of the retailer requesting the proposed transaction and the accessed authentication information comprising the real-time GPS location of the consumer associated with the proposed transaction, a risk score for the proposed transaction; and
determine whether to grant the authorization request based on the determined risk score.

20. The computer-readable medium of claim 19, wherein the transaction information comprises one or more of:
a name of the consumer;
a name of the retailer;
a location of the retailer; and
a dollar amount for the proposed transaction.

21. (canceled)

22. (canceled)

23. The computer-readable medium of claim 19, wherein:
the transaction information comprises a location of the retailer; and
determining the risk score comprises comparing the real-time (GPS location of the consumer with the location of the retailer.

24. The computer-readable medium of claim 23, wherein the determined risk score is increased if the real-time GPS location of the consumer does not match the location of the retailer.

25. (canceled)

26. (canceled)

27. The computer-readable medium of claim 19, wherein:
the transaction information comprises a dollar amount for the proposed transaction; and
the logic is further operable when executed to:
compare the dollar amount for the proposed transaction with a minimum transaction amount specified by the consumer; and
access the authentication information for the consumer in response to determining that the dollar amount for the proposed transaction exceeds the minimum transaction amount specified by the consumer.
